(19) United States
(12) Patent Application Publication
(10) Pub. No.: US 2012/0105305 A1
(43) Pub. Date: May 3, 2012

(54) REFLECTARRAY

(75) Inventors: Tamami Maruyama, Kanagawa (JP); Tatsuo Furuno, Kanagawa (JP); Tomoyuki Ohya, Kanagawa (JP); Shinji Uebayashi, Aichi (JP); Koji Isshiki, Tokyo (JP)

(73) Assignee: NTT DOCOMO, INC., Tokyo (JP)

(21) Appl. No.: 13/375,043

(22) PCT Filed: May 28, 2010
(86) PCT No.: PCT/JP10/59153

§ 371 Date: Jan. 17, 2012

(30) Foreign Application Priority Data
May 29, 2009 (JP) 2009-131585

(51) Int. Cl. H01Q 15/14

(52) U.S. Cl. 343/912

(57) ABSTRACT

A reflectarray according to the present invention formed by arranging a plurality of mushroom structures on a ground plane and each of the mushroom structures is formed by one quadrilateral patch and a via configured to short the patch and the ground plane. The adjacent vias are arranged to have equal intervals in a vertical direction of the ground plane. A size of each gap between the adjacent patches is adjusted so that a value of a reflection phase of a reflected wave from can of the patches is set to a desired value.

### TECHNICAL FIELD

The present invention relates to a reflectarray. More specifically, the present invention relates to “design of a reflectarray using a left-handed transmission line model, a metamaterial or an EBG (electric band gap) structure”, “techniques for improving a propagation environment with application of a reflectarray”, “techniques for directional control of reflected waves with application of a reflectarray”, “an increase in MIMO transmission capacity with application of a reflectarray”, and so forth.

### BACKGROUND ART

Metamaterials have been intensively studied in recent years. As shown in Non-patent Document 1, a technique has been discussed to control a radiation direction by providing phase differences to reflected waves with use of tapered mushroom structures.

FIG. 1 shows a reflectarray 1 including conventional tapered mushroom structures disclosed in Non-patent Document 1. As shown in FIG. 1, the reflectarray 1 includes multiple patches 10, via holes 20 formed in the respective patches 10, a ground plane 30, and a substrate 40. The conventional tapered mushroom structures includes eleven patches 10 having difference lengths of L1 to L11. FIG. 2 shows detailed dimensions of the structures of FIG. 1.

As is apparent from FIG. 1 and FIG. 2, the reflectarray 1 using the conventional mushroom structures has been designed by correlating the lengths of the patches to phases. According to Japanese Patent Application Publication No. 2010-62689, FIG. 1 and FIG. 2 can be deemed to show a conventional designing method in which waves having polarized waves, whose electric fields are parallel to a y direction and perpendicular to an x direction, are controlled to be reflected waves in the x direction.

Next, a structure of the reflectarray 1 using the conventional mushroom structures is shown in FIG. 3 in which waves having similar polarized waves, e., the polarized waves whose electric fields are parallel to the y direction and perpendicular to the x direction, are controlled to be reflected waves in the y direction (see Japanese Patent Application Publication No. 2010-62689). In FIG. 3, “T” denotes an interval between adjacent via holes 20 and “PT” denotes an interval between adjacent patches 10. Here, “T=PT” holds true. A length in the y direction of each patch is “2×W_{yi}”.

Assuming that “g_{yi}=T−(2×W_{dyi})”, a gap between an i-th patch and an adjacent (i+1)-th patch is expressed by “(g_{yi}+g_{yi+1)}/2”.

For the conventional reflectarray 1 using the mushroom structures shown in FIG. 1 and FIG. 3, the lengths of the patches are determined by using values of reflection phases of the mushroom structures as similar to the design of the reflected array using conventional micro-strip patches (see Non-patent Document 2).

FIG. 4 shows a calculation example showing relationships between reflection phases and patch sizes of mushroom structures. FIG. 4 shows the relationships between the reflection phases and the patch sizes of mushroom structures in the case where the mushroom structures are square mushroom structures having the same size and periodically arranged at intervals of 2.4 mm. When the difference in the reflection phase between the mutually adjacent mushrooms is 24 degrees, the differences in patch size between these mushrooms are indicated with triangles in FIG. 4.

FIG. 5 shows the reflectarray 1 having the periodically arrayed mushroom structures. As apparent from FIG. 5, the size (g_{y}) of the gap corresponding to the patch length of “2×W_{y}” is expressed by “T−(2×W_{y})” in the periodically arrayed mushroom structures.

### PRIOR ART DOCUMENTS

### Non-Patent Documents

NON-PATENT DOCUMENT 1: K. Chang, J. Ahn and Y. J. Yoon, “High-impedance Surface with Nonidentical Lattices”, iWAT2009, p. 315 and pp. 474 to 477
NON-PATENT DOCUMENT 2: David M. Pozar, Stephen D. Targonski and H. D. Syrigos, “Design of Millimeter Wave Microstrip Reflectarrays”, IEEE TRANSACTIONS ON ANTENNAS AND PROPAGATION, VOL. 45, No. 2, February 1997, pp. 287 to 296
NON-PATENT DOCUMENT 3: D. Sievenpiper, “High-impedance Electromagnetic Surface”, Ph. D. dissertation, Department of Electrical Engineering, Univ. California, Los Angeles, Calif., 1999

### SUMMARY OF THE INVENTION

As shown above, according to the method of designing the reflectarray using the conventional mushroom structures, the lengths of the patches are determined by using the values of the reflection phases of the mushroom structures as similar to the method of designing the reflectarray using the micro-strip patches.

In the case of the micro-strip patches shown in Non-patent Document 2, the size of each of the patches is about a half of a wavelength and the reflection phase becomes zero at a frequency at which the patches resonate. In this context, the reflection phase can be considered to be determined by the patch size.

Meanwhile, the reflection phase in the case of the EBG structure or a left-handed material can be considered based on a left-handed transmission line model. Here, the principle will be briefly described by using FIG. 6 to FIG. 8. FIG. 6(a) and FIG. 6(b) show a conventional right-handed transmission line model. Here, if an inductor “L” and a capacitance “C” can be replaced in position with each other as shown in FIG. 7, a left-handed transmission line model can be created having a negative phase constant. Mushroom structures shown in FIG. 8(a) and FIG. 8(b) have been designed for achieving this model (see Non-patent Document 3), in which the capacitance “C” between transmission lines is configured as shown in (Formula 1) by using the gap “g_{y}” between the patches of the mushroom structures. Here, the same reference numerals are used as those used in FIG. 3.

$$\begin{matrix}[ Expression 1 ] & \\ C = \frac{{ɛ}_{0} ( 1 + {ɛ}_{r} ) {W}_{x}}{π} arccos h \frac{PT}{{g}_{y}} & ( Formula 1 )\end{matrix}$$

Meanwhile, inductance “L” is expressed by (Formula 2) where a thickness of the substrate is denoted by “t” and magnetic permeability thereof is denoted by “μ”.

L=μ·t (Formula 2)

Here, the general magnetic permeability “μ” of the substrate may be approximated by free space magnetic permeability μ0 when no ferromagnet is used in the substrate.

Meanwhile, surface impedance “Zₛ” is expressed by (Formula 3) by using “L” and “C”.

Zₛ=jωL/(1−ω²LC) (Formula 3)

The phase of the reflected wave of each of the mushroom structures can be obtained from (Formula 4) by using the above-described formula and the left-handed transmission line model. Specifically, if a reflector is formed by arranging the mushroom structures as shown in FIG. 3 and a phase of a reflection coefficient “Γ” for making a plane wave incident in a z-axis direction is denoted by “φ”, the reflection coefficient “Γ” can be expressed as shown in (Formula 4) by using free space impedance “η” and surface impedance “Zₛ”.

Γ=(Zₛ=η)/(Zₛ+η)=|Γ|exp(jφ) (Formula 4)

If a phase difference of the reflection coefficient from that of the adjacent mushroom structure is denoted by “Δφ”, a desired direction “α” of the reflected wave can be expressed by (Formula 5).

α=sin⁻¹((λ·Δφ)/(2π·PT)) (Formula 5)

In the case of the left-handed transmission line model using the mushroom structures, the reflection phase is dominated by the value of the capacitance which is determined by the gap between the patches, as described above.

Specifically, when the reflectarray is formed by the mushroom structures using the patches far smaller than a wavelength, the value of the capacitance of the left-handed transmission line model is determined by the size of the gap. Accordingly, the reflection phase is dominated more by the space of the gap than by the length of the patch. On the other hand, in the case of the reflectarray using a conventional micro-strip array using the patch about half as long as the wavelength, the resonant frequency is determined by the length of the patch. Accordingly, the reflection phase is dominated more by the length of the patch than by the gap between the patches.

As described above, the value of the capacitance is determined based on the size of the gap in the case of the left-handed transmission line model. Nevertheless, if the lengths of the patches are determined based on the phases in FIG. 4 by using the conventional method of designing a reflectarray as shown in Non-patent Document 2, the left-handed transmission line model has a problem that the value of the gap is “(g_{yi}+g_{y1+1})/2” as shown in FIG. 3, and cannot be set to “g_{yi}”.

FIG. 9 is a graph with the gap on the horizontal axis and the reflection phase on the vertical axis. In FIG. 9, triangular symbols plot values of the phases corresponding to the sizes of the respective gaps “(g_{yi}+g_{yi+1})/2” in the case of determining the lengths of the patches as shown in FIG. 4.

Circular symbols represent values of the gaps selected to cause the difference in the reflection phase to be 24 degrees. It is understood that those values are different between the two cases.

Values based on the above-described theoretical formulae (Formula 1) to (Formula 5) are indicated with a curved line A in FIG. 10. It is apparent that tendencies between theoretical values and analyzed value fairly agree with one another. In other words, the analyzed values of the reflection phase of the reflectarray fairly agree with the theoretical values based on the left-handed transmission line model.

FIG. 11 shows phase differences (triangular symbols) in the case of using the method of designing the conventional reflectarray for determining the lengths of the patches and phase differences (circular symbols) in the case of using the method for determining the sizes of the gaps. As shown in FIG. 11, the phase difference is not constant in the case of determining the lengths of the patches based on the method of designing the conventional reflectarray. Hence there is a limitation to improve a performance of the reflectarray.

Accordingly, the present invention has been made in view of the aforementioned problem, and an objective thereof is to provide a reflectarray using a metamaterial based on a left-handed transmission line model and having an improved performance as compared to a conventional method.

The first feature of the present invention is summarized in that a reflectarray (reflectarray 1) formed by arranging a plurality of mushroom structures on a ground plane (ground plane 30), wherein each of the mushroom structures includes one quadrilateral patch (patch 10) and a via (via hole 20 for example) configured to short the patch and the ground plane, the adjacent vias are arranged to have equal intervals in a vertical direction of the ground plane (same direction with electric field), and a size of each gap between the adjacent patches is adjusted so that a value of a reflection phase of a reflected wave from each of the patches is set to a desired value. Incidentally, the adjacent vias may be arranged to have equal intervals in a vertical direction as well as a horizontal direction of the ground plane.

The second feature of the present invention, is summarized in that a reflectarray formed by arranging a plurality of mushroom structures on a ground plane, wherein each of the mushroom structures includes one quadrilateral patch; and a via configured to short the patch and the ground plane, when an interval “PT” from an edge of an i-th patch to an edge of an (i+1)-th patch is set to an equal value for all i parameters and a size of a gap between an i-th patch “Pᵢ” and an adjacent (i+1)-th patch “P₁₊₁” is denoted by “g_{yi}”, a length of the i-th patch is “2×W_{yi}”, and an interval “IVhᵢ” between an i-th via “Vhᵢ” and an (i+1)-th via “Vhᵢ₊₁” is “W_{yi}+g_{yi}+W_{yi+1}”.

The third feature of the present invention is summarized in that A reflectarray formed by arranging a plurality of mushroom structures on one ground plane, wherein each of the mushroom structures comprises one quadrilateral patch, every interval between a center bisecting a gap between the adjacent patches and a center bisecting an adjacent gap adjacent to the gap is set equal in a vertical direction of the ground plane, and a size of the gap is adjusted so that a value of a reflection phase of a reflected wave from each of the patches is set to a desired value. Incidentally, the adjacent vias may be arranged to have equal intervals in a vertical direction as well as a horizontal direction of the ground plane.

A fourth feature of the present invention is summarized in that a reflectarray (reflectarray 1) to be formed by arranging multiple mushroom structures on a ground plane (ground plane 30), wherein each of the mushroom structures includes a v a-less structure formed of one quadrilateral patch (patch 10) and the ground plane. Here, centers of gaps between the patches constituting the mushrooms are arranged to have equal intervals. A size of the gap between the adjacent patches is adjusted to set a value of a reflection phase of a reflected wave from the patches to a desired value.

In the first through fourth feature of the present invention, in a portion where there is no value of a gap “Δg” corresponding to the reflection phase “φ”, none of the mushroom structures may be arranged on a surface of the reflectarray and the ground plane may not be provided on a rear surface of the reflectarray, and in a portion where there is a value of the gap “Δg” corresponding to the reflection phase “φ”, one of the mushroom structures may be arranged on the surface of the reflectarray and the ground plane may be provided on the rear surface of the reflectarray.

In the first feature of the present invention, when the interval between the vias is denoted by “T” and a size of a gap between an i-th patch “Pᵢ” and an adjacent (i+1)-th patch “Pᵢ₊₁” is denoted by “g_{yi}”, the gap is located between an i-th via “Vhᵢ” and an adjacent (i+1)-th via “Vhᵢ₊₁”, the size “g_{yi}” of the gap may be determined based on a value of a phase of a reflected wave that is an incident wave reflected by each of the patches, and when a difference obtained by subtracting the size “g_{yi}” of the gap from the interval “T” of the vias is “2×W_{yi}” and a length of the patch from each of the vias “Vhᵢ” and “Vhᵢ₊₁” to the gap is “W_{yi}”, a length of the i-th patch may be “W_{y(i-1)}+W_{yi}”.

A fifth feature of the present invention is summarized in that a reflectarray formed by the mushroom structures, wherein the size of the gap generated between the mushrooms is determined so that an equal phase, surface of the reflection phase is oriented to a desired reflection direction. Moreover, the gaps g_{yi} are arranged at an even interval PT and a length of half the length of the patch defined by a difference between the interval PT and the gap g_{yi} is provided at both ends of the gap so that the length of the gap is denoted by g_{yi}+g_{yi+1}.

Meanwhile, a sixth feature of the present invention is summarized in that a reflectarray to be formed by arranging multiple mushroom structures on a ground plane, wherein each of the mushroom structures includes one quadrilateral patch. Here, an interval between the adjacent patches is denoted by a gap, and a value of each gap is determined based on a relation between the value of the gap and a reflection phase so that an equal phase surface of a reflected wave is orthogonal to a desired direction.

In the above-described features, the centers of the gaps may be arranged at an even interval T, and when a gap between the patch i and the adjacent path i+1 is denoted by gij, a length of the patch i in the electric field direction may be set to ((T−g_{i-1,i})+(T−g_{i,i+1}))/2.

In the above-described features, end points of the gaps may be arranged at an even interval PT and a length of the patch in the electric field direction may be set to (T−g_{i,+1})/2.

In the above-described features, each of the mushrooms may include a via configured to short the ground plane and the patch, and the via may be arranged at an even interval T/2 from centers of the gaps.

In the above-described features, each of the mushrooms may include a via configured to short the ground plane and the patch, and the via may be arranged at the center of each patch.

In the above-described features, the via maybe formed as a mark for determining a position on the patch instead of using the above-described via structure, and the mushrooms may be formed of the ground plane and the patch.

### BRIEF DESCRIPTION OF THE DRAWINGS

FIG. 1 is a view showing a structure of a conventional reflectarray.

FIG. 2 is a table showing detailed dimensions of the structure of the conventional reflectarray.

FIG. 3 is a view showing a structure of a conventional reflectarray.

FIG. 4 is a graph showing an example of relationships between reflection phases and patch sizes in the structure of, the conventional reflectarray.

FIG. 5 is a view showing a structure of a conventional reflectarray.

FIG. 6 is a view for explaining a right-handed transmission line model.

FIG. 7 is a view for explaining a left-handed transmission line model.

FIG. 8 is a view for explaining a “2D LH mushroom structure”.

FIG. 9 is a graph showing an example of relationships between reflection phases and gaps in the structure of the conventional reflectarray.

FIG. 10 is a graph showing an example of relationships between the reflection phases and the gaps in the structure of the conventional reflectarray.

FIG. 11 is a graph showing an example of phase differences between adjacent elements in the structure of the conventional reflectarray.

FIG. 12 is a view showing a structure of a reflectarray according to a first embodiment of the present invention.

FIG. 13 is a view showing a detailed structure of the reflectarray according to the first embodiment of the present invention.

FIG. 14 is a table showing detailed dimensions of the structure of the reflectarray according to the first embodiment of the present invention.

FIG. 15 is a view for explaining an effect of the structure of the reflectarray according to the first embodiment of the present invention.

FIG. 16 is a view showing a structure of reflectarray according to a second embodiment of the present invention.

FIG. 17 is a view for explaining an effect of the structure of the reflectarray according to, the second embodiment of the present invention.

FIG. 18 is a view showing a detailed structure of a reflectarray according to a third embodiment of the present invention.

FIG. 19 is a table showing detailed dimensions of the structure of the reflectarray according to the third embodiment of the present invention.

FIG. 20 is a view for explaining an effect of the structure of the reflectarray according to the third embodiment of the present invention.

FIG. 21 is a view showing a structure of a reflectarray according to a fourth embodiment of the present invention.

FIG. 22 is a contour map of phases of a reflected wave in the reflectarray according to the fourth embodiment of the present invention.

FIG. 23 is a contour map of phases of a reflected wave for making a comparison with the reflectarray according to the fourth embodiment of the present invention.

FIG. 24 is a view for explaining an effect of the structure of the reflectarray according to the fourth embodiment of the present invention.

FIG. 25 is a view for explaining an effect of the structure of the reflectarray according to the fourth embodiment of the present invention.

FIG. 26 is a graph showing an example of relationships between reflection phases and gaps in the structure of the reflectarray according to the fourth embodiment of the present invention.

FIG. 27 is a view showing a detailed structure of the reflectarray according to the fourth embodiment of the present invention.

FIG. 28 is a view showing a structure of a reflectarray according to a fifth embodiment of the present invention.

FIG. 29 is a view showing an entire structure of the reflectarray according to the fifth embodiment of the present invention.

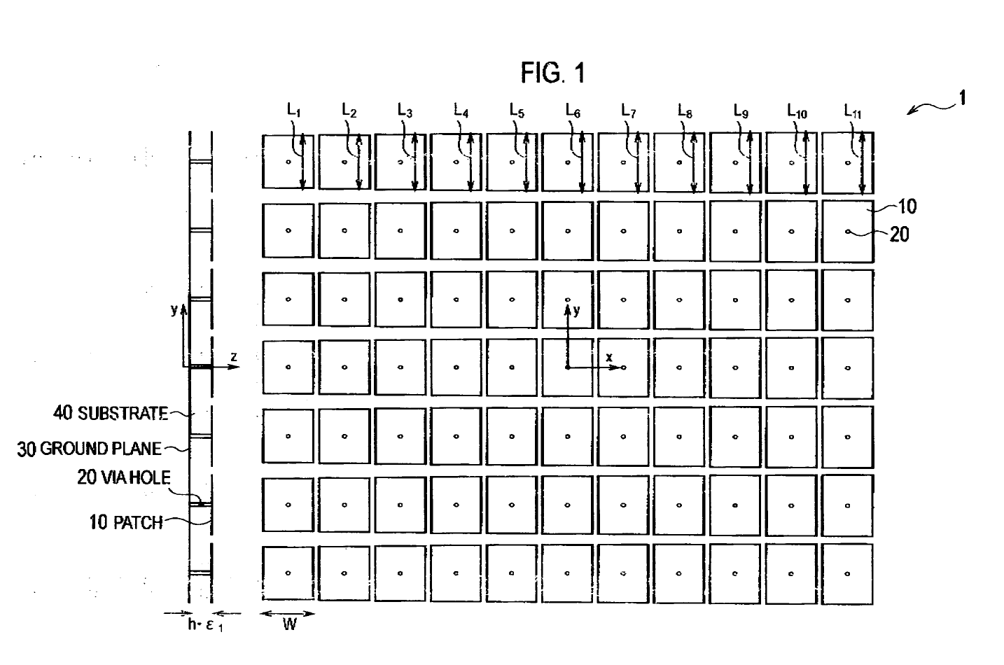

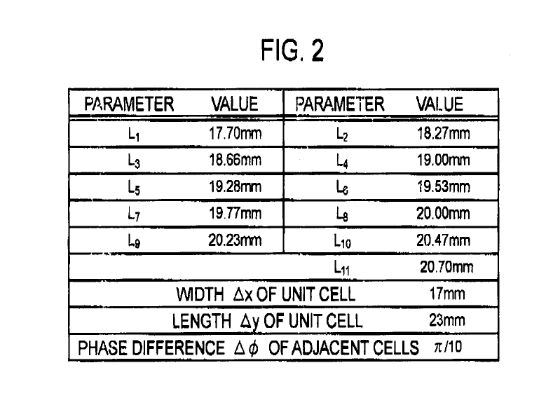

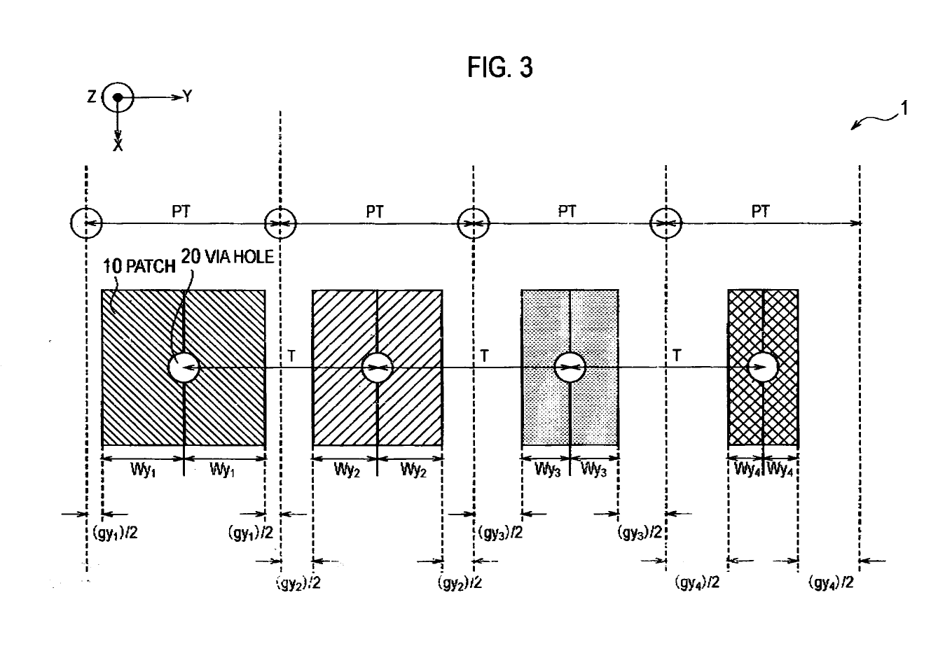

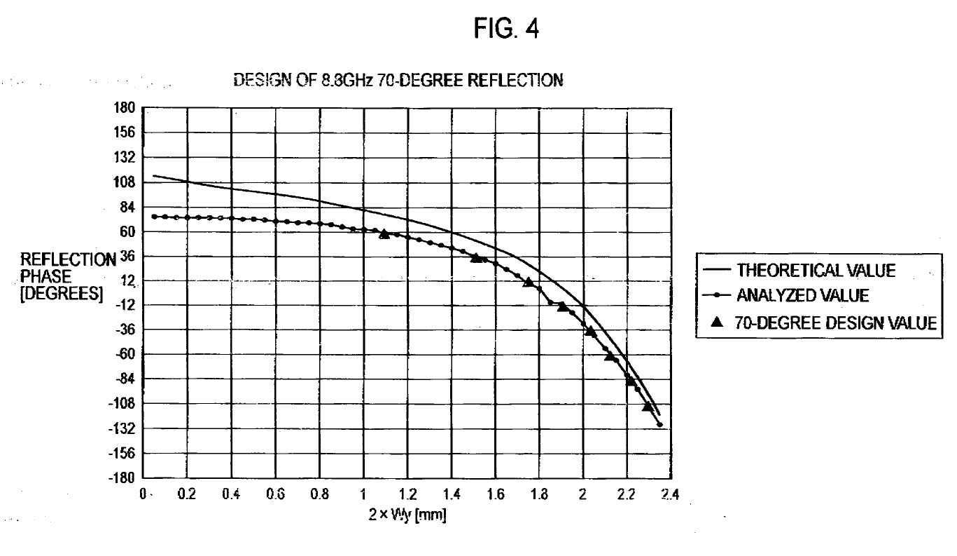

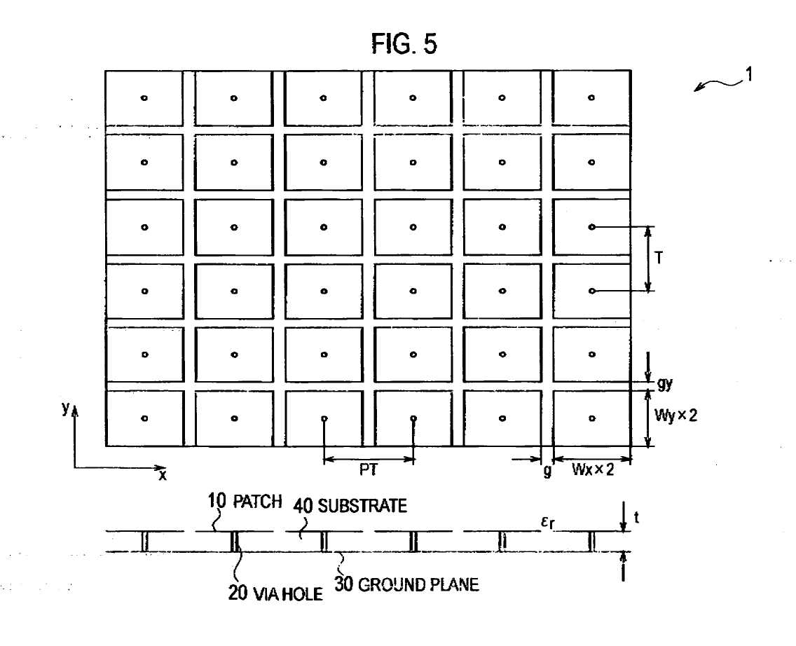

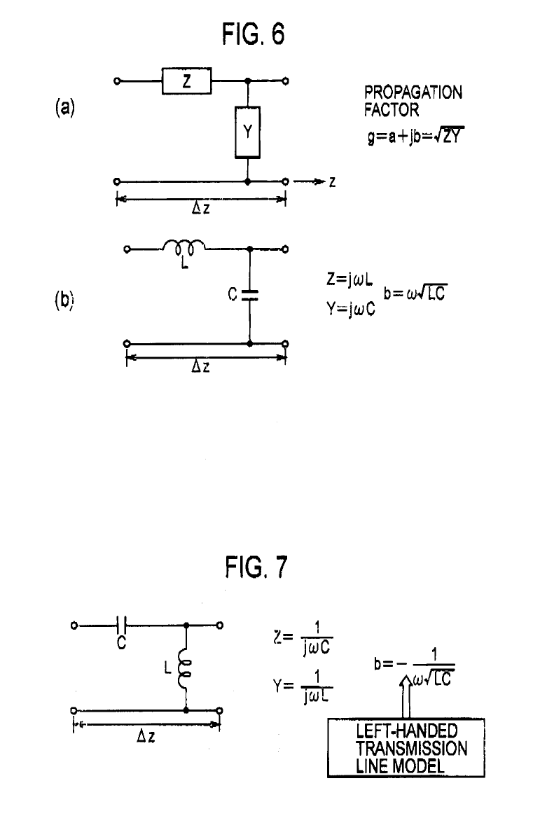

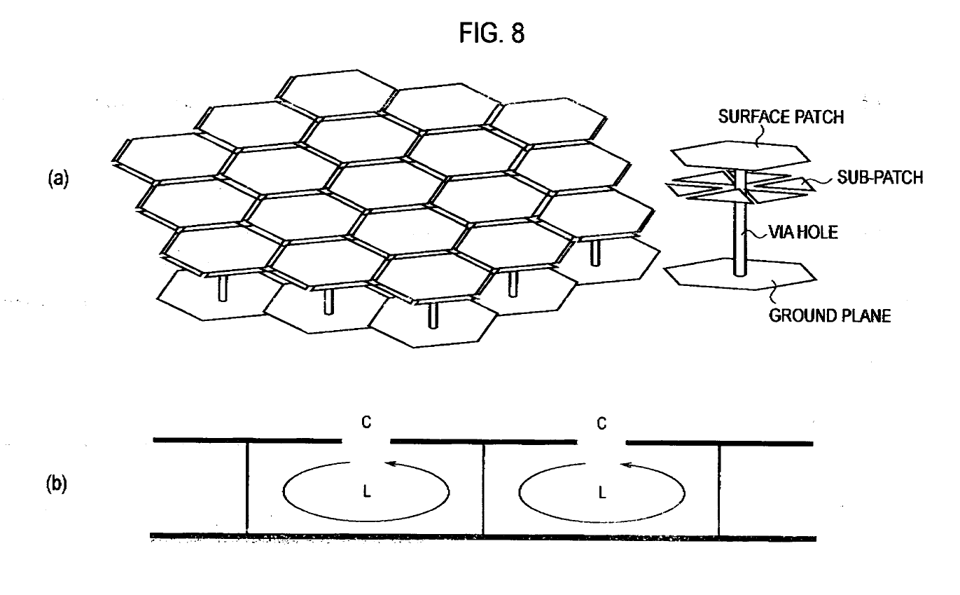

### MODES FOR CARRYING OUT THE INVENTION

Embodiments of the present invention will be described in detail below with reference to the accompanying drawings.

### First Embodiment of the Present Invention

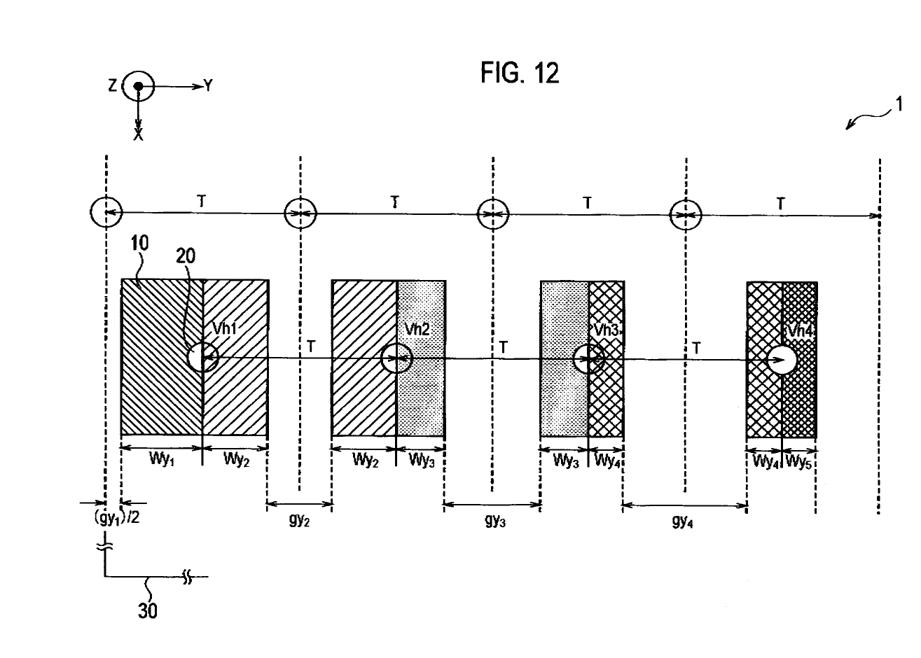

FIG. 12 shows a reflectarray 1 using a metamaterial according to a first embodiment of the present invention. As shown in FIG. 12, the reflectarray 1 is formed by arranging multiple mushroom structures on a ground plane 30.

Each of the mushroom structures includes one quadrilateral patch 10 and a via hole 20 configured to short the patch 10 and the ground plane 30. Here, the adjacent via holes 20 are arranged to have equal intervals respectively in a horizontal direction (an x direction) and in a vertical direction (a y direction) of the ground plane 30. Here, the interval in the horizontal direction and the interval in the vertical direction do not always have to be the same but may be different from each other.

A size of a gap between the adjacent patches 10 is adjusted so that a value of a reflection phase of a reflected wave by the reflect array 1 is set to a desired value. Further details will be described below.

In this embodiment, “Δφ” is set to “24 degrees”, “PT” is set to “2.4 mm”, a frequency is set to “8.8 GHz”, and “α” in (Formula 5) is set to “70 degrees”.

In FIG. 12, an interval between the via holes is denoted by “T” and gap between an i-th patch “Pᵢ” and an adjacent (i+1)-th patch “Pᵢ₊₁” is denoted by “g_{yi}”.

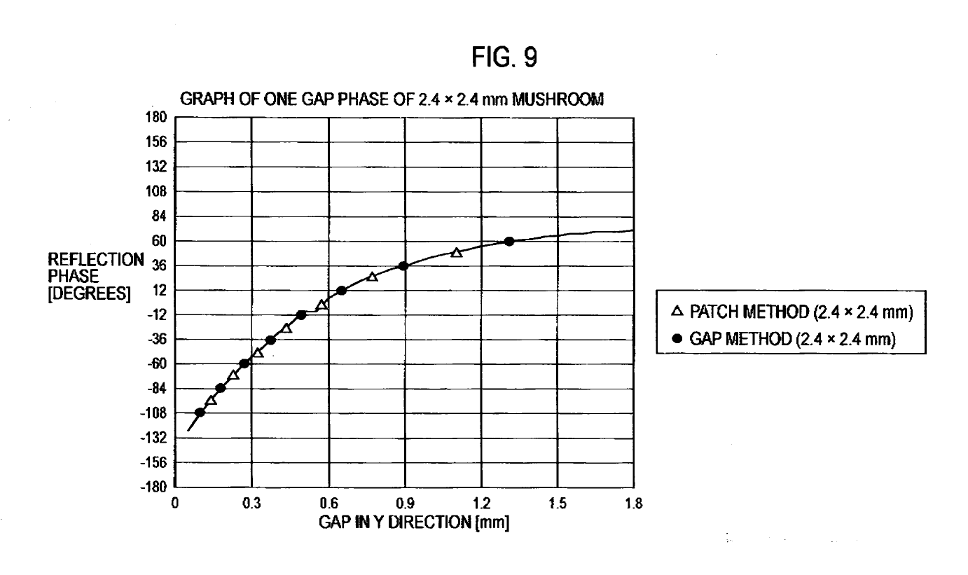

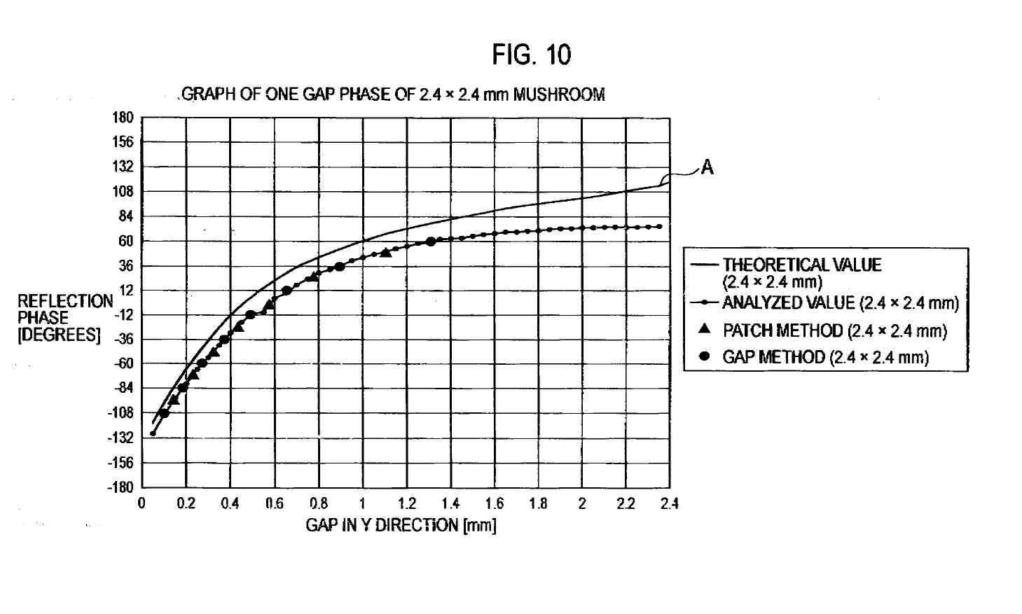

Each gap is located between an i-th via hole “Vhᵢ” and an adjacent via hole “Vhᵢ₊₁”. The value of the size of the gap “g_{yi}” is equivalent to a value of a phase of a reflected wave that is an incident wave reflected by each patch and is determined by FIG. 9.

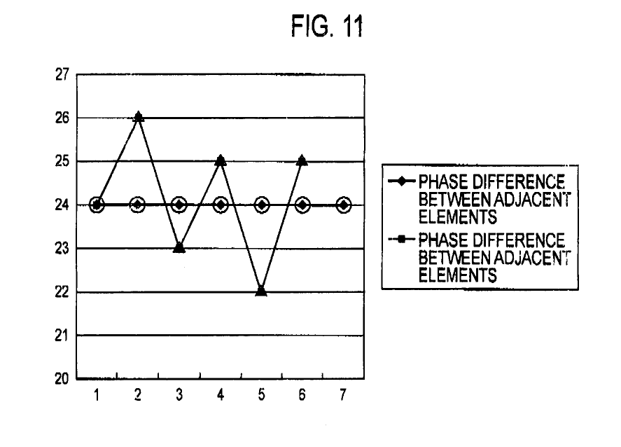

When a difference obtained by subtracting the size of the gap “g_{yi}” from the interval “T” of the via holes is denoted by “2×W_{yi}”, a length of each patch is determined as shown in FIG. 11. Here, a length of the patch from the via hole “Vhᵢ” to the gap “g_{yi}” is denoted by “W_{yi}” and a length of the patch from the via hole “Vhᵢ₊₁” to the gap “g_{yi}” is denoted by “W_{yi}”.

At this time, the length of the i-th patch is “W_{y(i-1)}+W_{yi}”. By designing as shown in FIG. 11, it is possible to set the gap to a desired value while maintaining a pitch at an even interval.

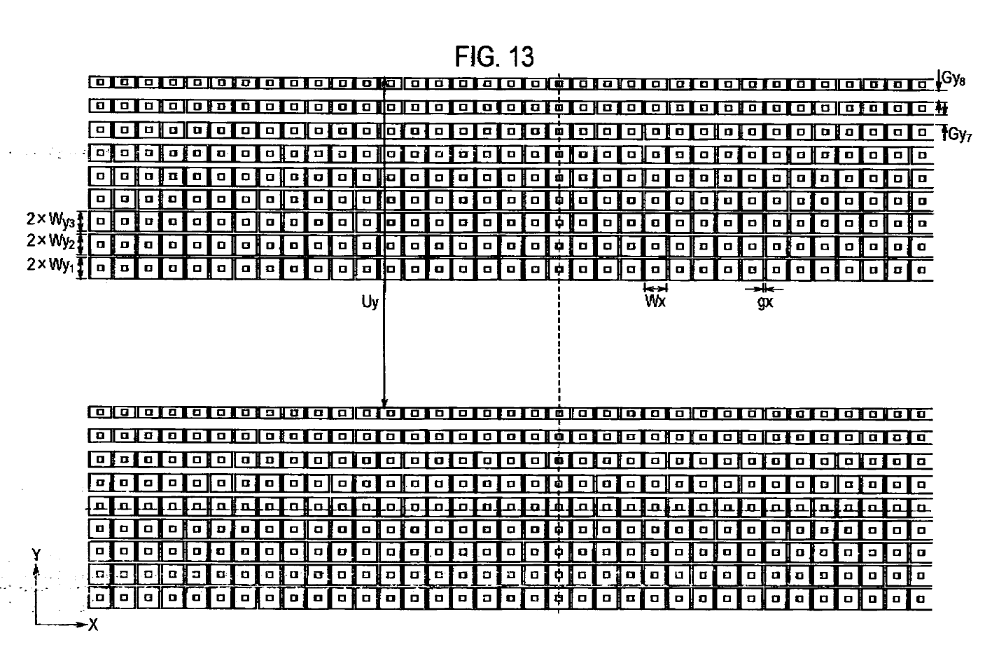

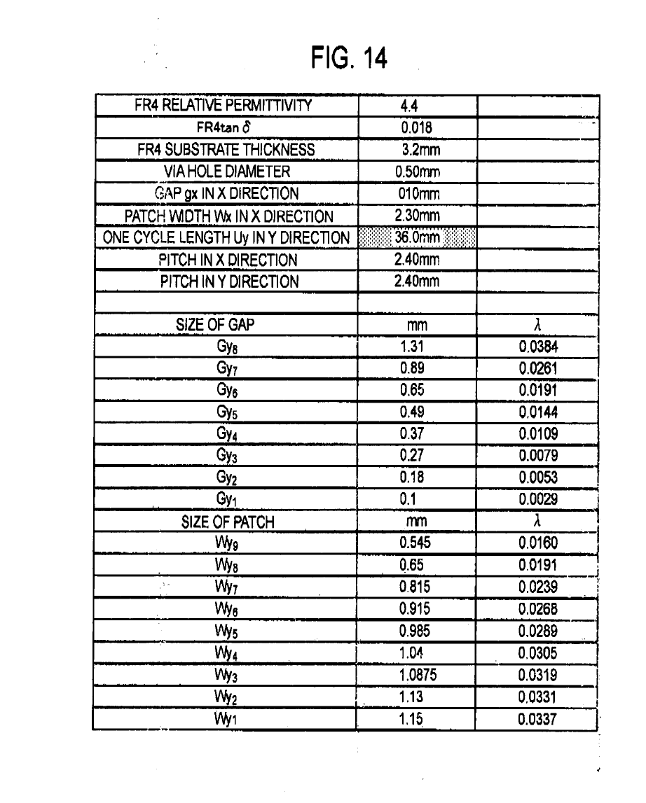

FIG. 13 shows a detailed structure of the reflectarray according to the first embodiment of the present invention. FIG. 14 shows detailed dimensions of the structure of the reflectarray according to the first embodiment of the present invention.

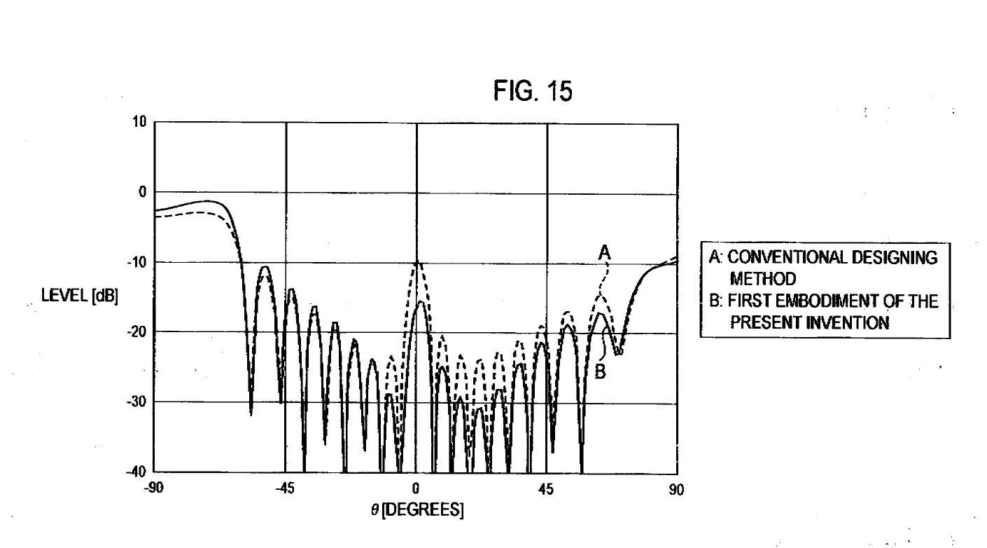

FIG. 15 shows an effect of the structure of the reflectarray according to the first embodiment of the present invention. FIG. 15 shows calculated values of a far scattered field on a Z-Y plane.

In FIG. 15, a solid line B indicates a result with the reflectarray using a metamaterial designed based on values of the gaps of the present invention, and a solid line A indicates a result with a reflectarray using a conventional metamaterial designed based on values of patches.

Concerning desired radiation in a direction of −70 degrees, the reflectarray according to this embodiment shows a higher level. On the other hand, concerning a regular reflection direction (in a direction of zero degrees), which is an unnecessary direction, the reflectarray according to this embodiment shows a lower level. Hence it is possible to confirm an effect of the reflectarray according to this embodiment.

Specifically, according to the reflectarray of this embodiment, the reflection phase tends to coincide with an ideal value of a left-handed transmission line model. Hence it is possible to suppress a situation where the phase difference is not constant as observed in the case of determining the lengths of the patches based on the method of designing the conventional reflectarray. In short, it is possible to significantly improve a performance of the reflectarray.

Although the via holes 20 are used in this embodiment, vias (conductive cylinders) made of short-circuit lines may be used instead of the via holes 20.

### Second Embodiment of the Present Invention

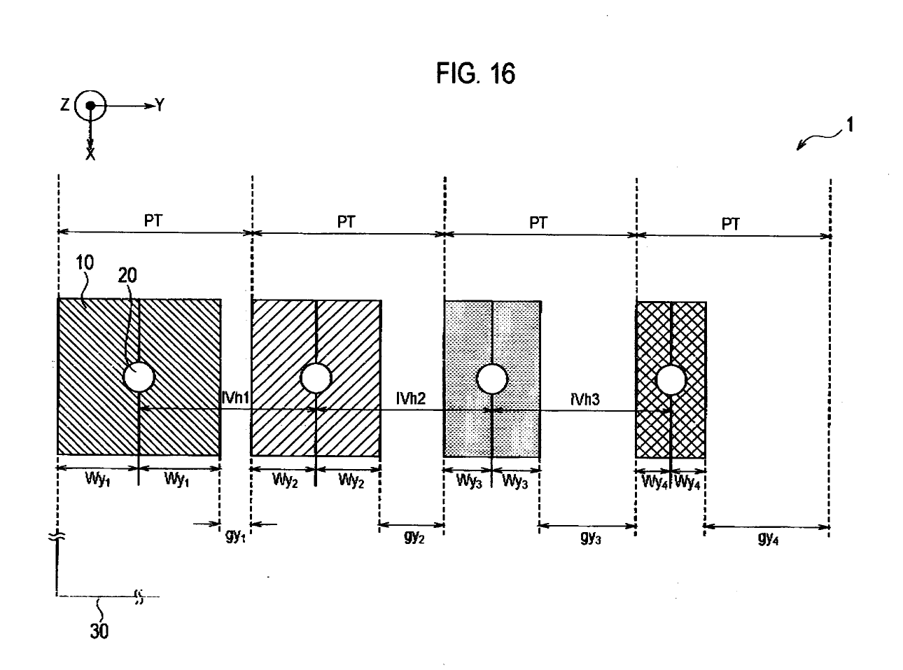

FIG. 16 shows a reflectarray 1 using a metamaterial according to a second embodiment of the present invention. In the following, portions different from those described in the first embodiment will be mainly explained and description of the identical portions will be omitted as appropriate.

In FIG. 16, an interval “PT” from an edge of an i-th patch to an edge of an (i+1)-th patch is set to an identical value for all i parameters, and a gap between an i-th patch “Pᵢ” and an adjacent (i+1)-th patch “Pᵢ₊₁” is denoted by “g_{yi}”.

At this time, assuming that a length of the i-th patch is “2×W_{yi}”, an interval “IVhᵢ” between an i-th via hole “Vhᵢ” and an (i+1)-th via hole “Vhᵢ₊₁” is “W_{yi}+g_{yi}+W_{yi+1}”.

In this way, it is possible to set all the patches at the gap interval designed by the phases in FIG. 9. However, in the case of the reflectarray according to the second embodiment, each of the intervals between the via holes is not constant but is the value calculated by “W_{yi}+g_{yi}+W_{yi+1}”.

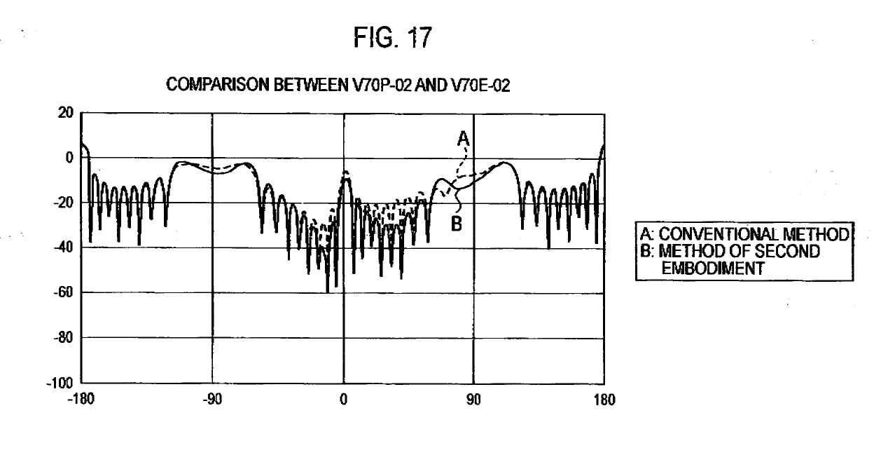

An effect of the reflectarray according to the second embodiment of the present invention will be described with reference to FIG. 17, FIG. 17 shows calculated values of a far scattered field on the Z-Y (plane.

In FIG. 17, a solid line A indicates a result with the reflectarray using the metamaterial designed based on the values of the gaps of the present invention, and a solid line B indicates a result with the reflectarray using the conventional metamaterial designed based on values of patches.

Concerning the desired radiation in the direction of −70 degrees, the reflectarray according to this embodiment shows a higher level. On the other hand, concerning the regular reflection direction (in the direction of zero degrees), which is the unnecessary direction, the reflectarray according to this embodiment shows a lower level. Hence it is possible to confirm an effect of the reflectarray according to this embodiment.

### Third Embodiment of the Present Invention

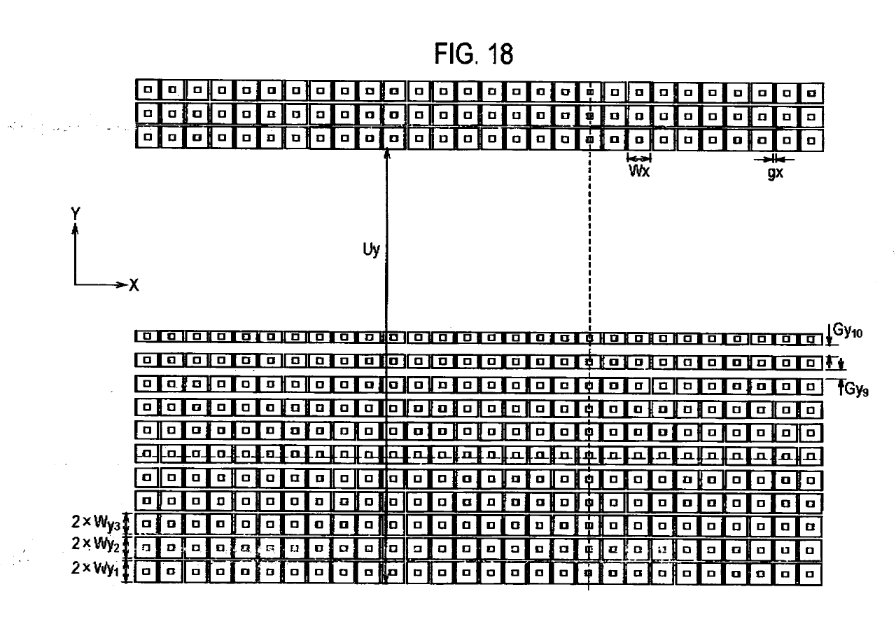

FIG. 18 shows a reflectarray using a metamaterial according to a third embodiment of the present invention.

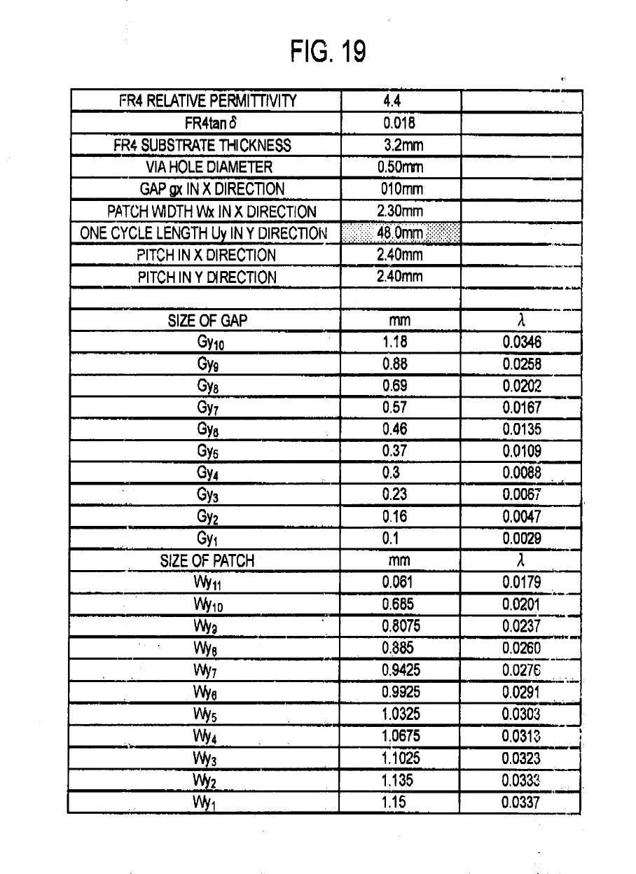

FIG. 18 shows a detailed structure of a reflectarray for directing a reflective wave to a direction of −45 degrees according to the third embodiment of the present invention. FIG. 19 shows detailed dimensions of the structure of the reflectarray according to the third embodiment of the present invention.

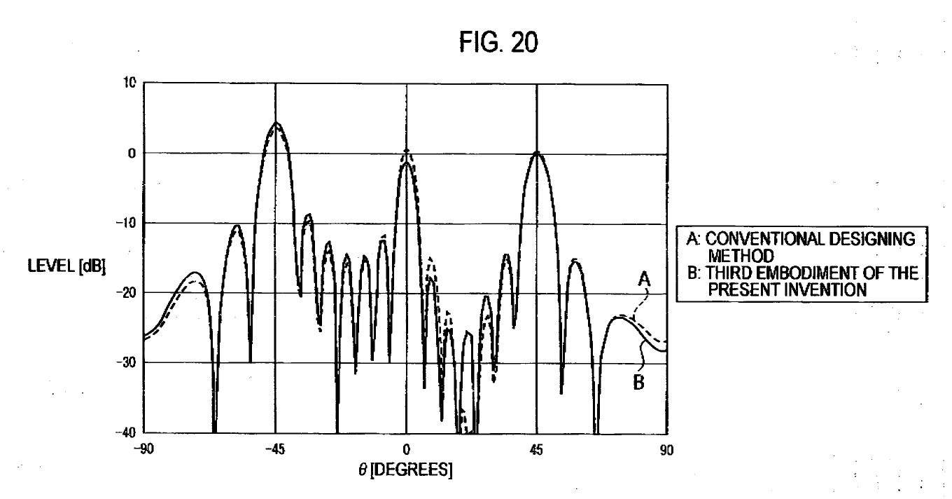

A comparison between a far scattered field of this embodiment and the conventional result is shown in FIG. 20. According to FIG. 20, it is possible to confirm that the reflectarray of this embodiment shows a slightly higher level of radiation in a desired direction of −45 degrees and a reduced level of radiation in an unnecessary direction of 0 degrees.

### Fourth Embodiment of the Present Invention

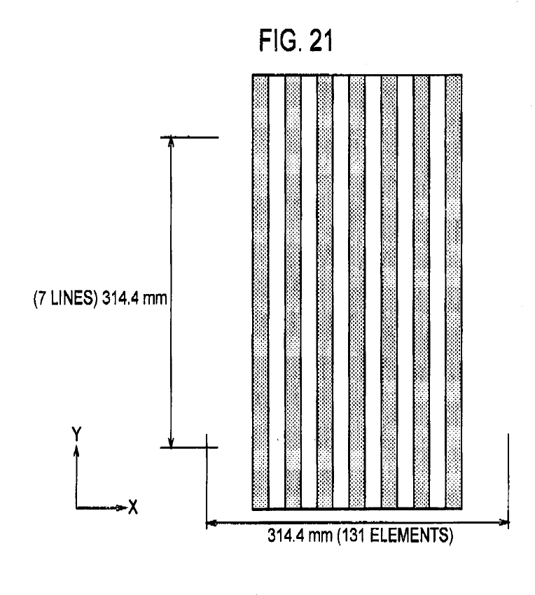

FIG. 21 shows a reflectarray using a metamaterial according to a fourth embodiment of the present invention.

As shown in FIG. 21, the reflectarray according to the fourth embodiment of the present invention is intended to radiate in the direction of −45 degrees as similar to the reflectarray according to the third embodiment, and is formed by periodically arraying the structures shown in FIG. 18 in the x direction and the y direction.

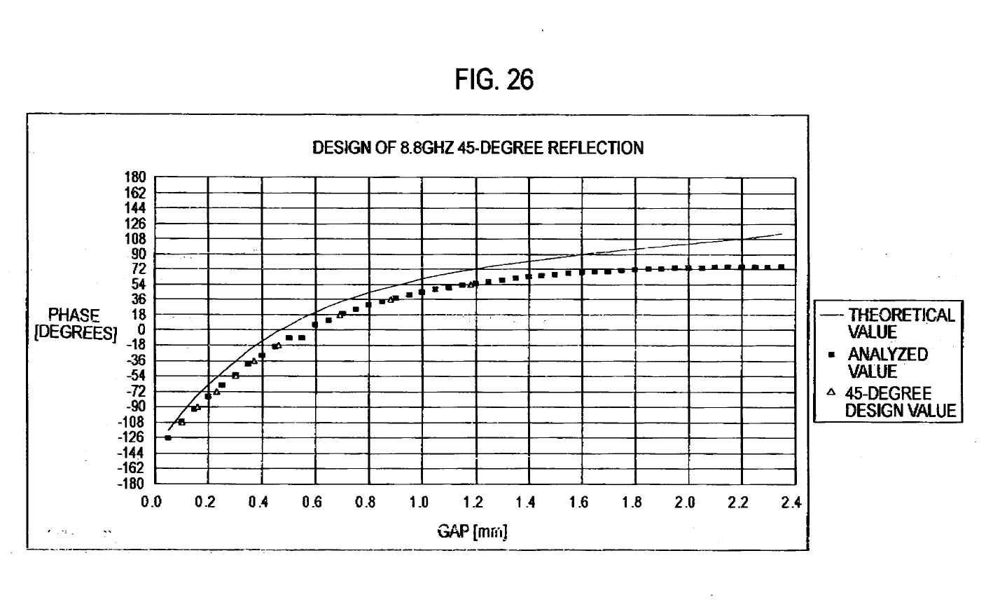

FIG. 26 shows relationships between the gaps used in this design and the reflection phases. In FIG. 26, values indicated with triangles are the designed values, for which the phase is selected at every 18 degrees. A selectable range at this time is defined from −126 degrees to 72 degrees. There is no selectable structure for phases outside this range.

Here, a portion without arrangement of the patches represents a location where there are no gaps that can obtain the desired reflection phase.

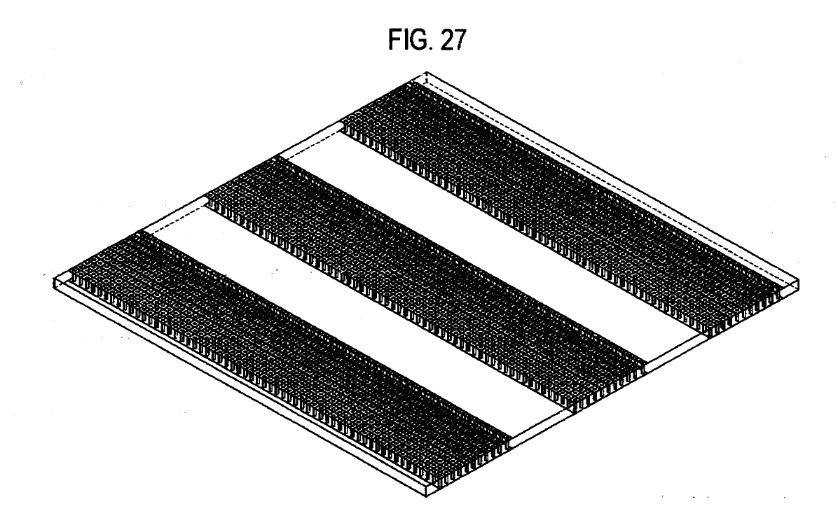

In the reflectarray according to this embodiment, metal on a rear surface without arrangement of the patches is peeled off. FIG. 27 shows the structure after the metal is peeled off the rear surface at the portion without arrangement of thy patches.

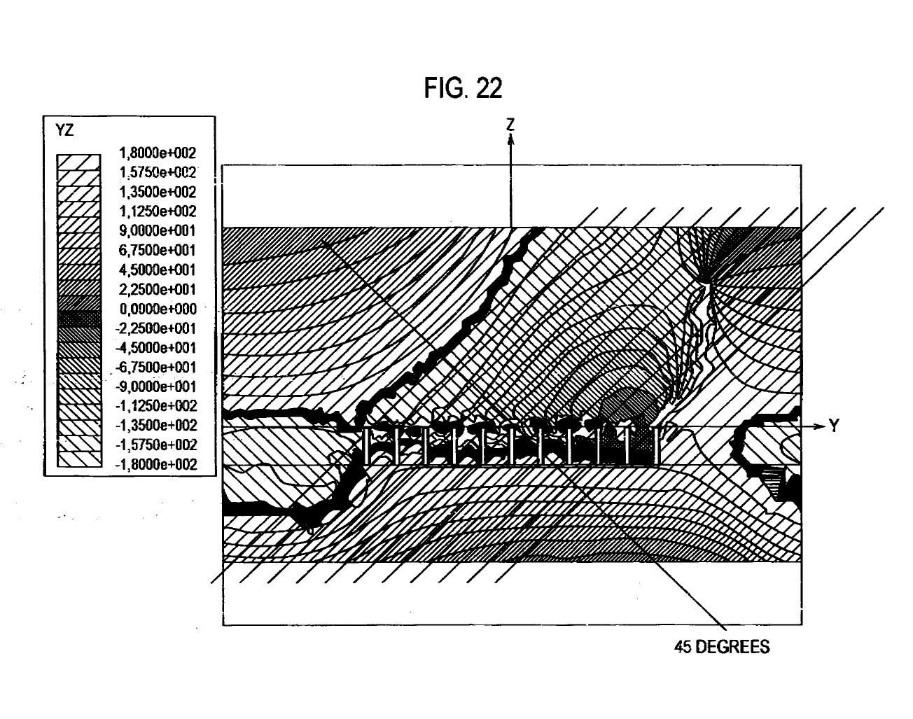

FIG. 22 shows phases of a reflected wave from a reflector at this time. FIG. 22 is a contour map of the phases of the reflected wave in the reflectarray according to this embodiment. It is apparent from FIG. 22 that an equal phase surface is aligned in a direction of 45 degrees from the z axis.

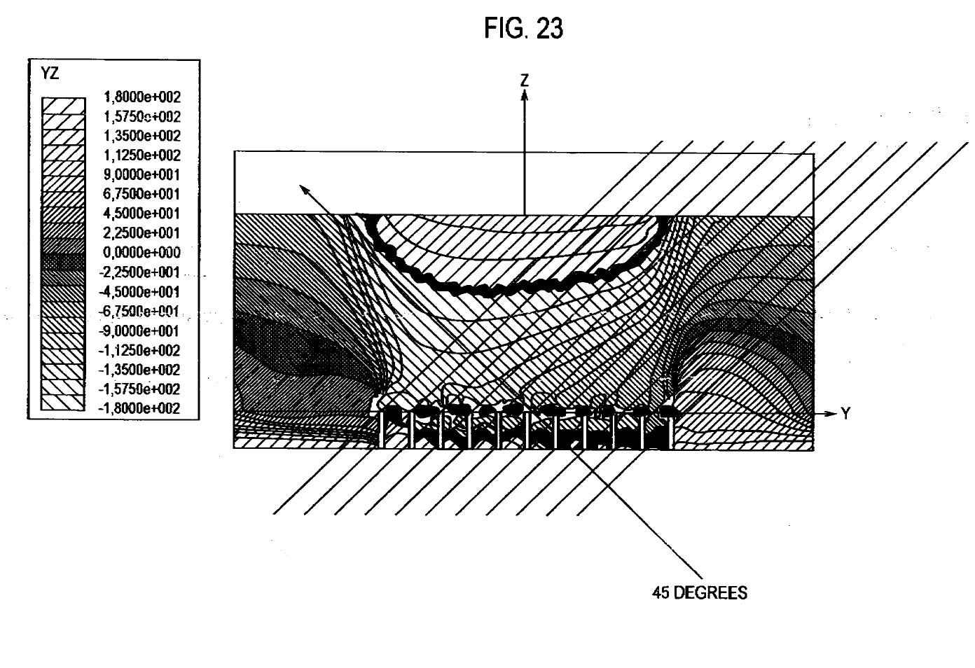

FIG. 23 is a contour map of the phases of the reflected wave when the metal is formed on the entire rear surface which is provided for comparison with FIG. 22.

As shown in FIG. 23, the phases are aligned in the desired direction where the patches are provided on the surface. However, the reflected wave is likely to be radiated in the direction of normal reflection where there are no patches on the surface. Hence it is possible to confirm that the phases of the reflected waves fail to form equal phases in the desired direction.

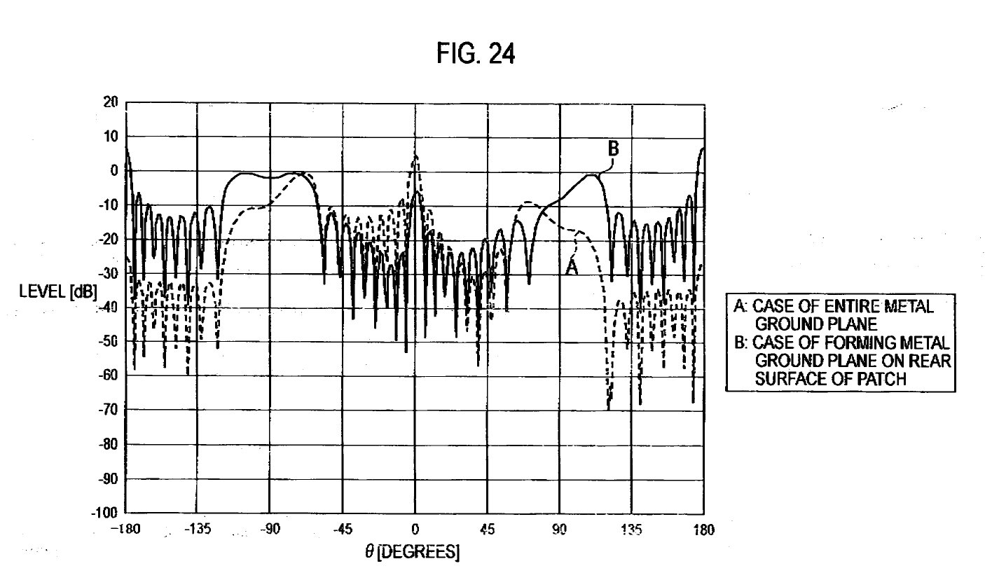

As similar to the first embodiment of the present invention, FIG. 24 shows a result of comparison between a far radiated field on a Y-Z plane in the case of forming the metal on the entire rear surface and a far radiated field on the Y-Z plane in the case of forming the metal only when the patches are arranged, in a model for an element array with a focus on the gap interval.

In FIG. 24, the array of the elements on the surface is similar to that of the first embodiment and a beam control angle is set to −70 degrees in the design.

In FIG. 24, a solid line A shows the case of forming the metal on the entire rear surface, and a solid line B shows the case of forming the metal only on the rear surfaces of the patches. In both cases, the beam is oriented in the desired direction of −70 degrees.

However, when the metal is formed on the entire rear surface, a radiation level in the direction of 0 degrees representing specular reflection is higher than a radiation level in the direction of −70 degrees. Specifically, as shown in the fourth embodiment of the present invention, it is understood that the model prepared by forming the metal ground plane only on the rear surfaces of the patches and peeling the metal of an inner surfaces of the patches shows a better characteristic.

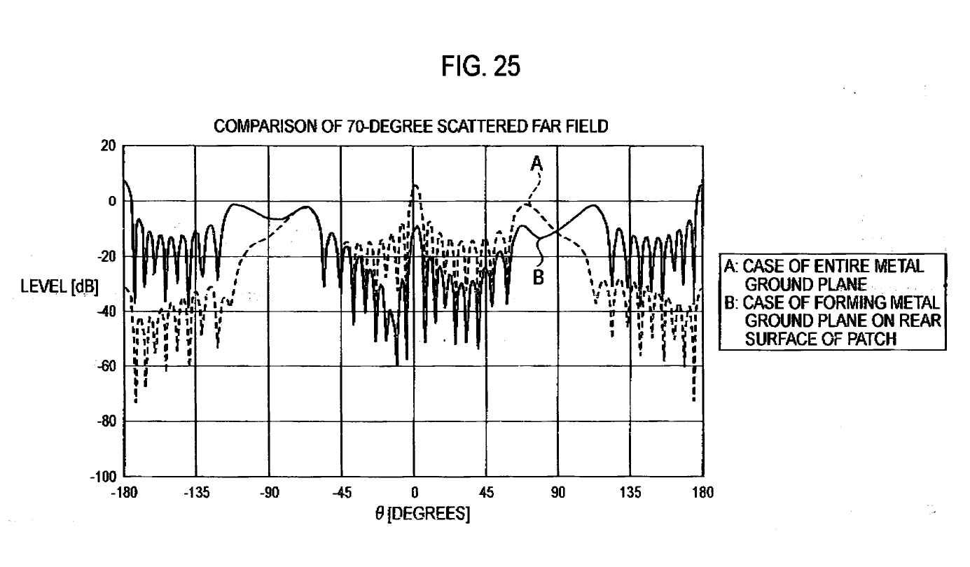

As similar to the second embodiment of the present invention, FIG. 25 shows a result of comparison between a far radiated field on the Y-Z plane in the case of forming the metal on the entire rear surface and a far radiated field on the Y-Z plane in the case of forming the metal only when the patches are arranged, in the model for the element array with a focus on the gap interval.

In FIG. 25, the array of the elements on the surface is similar to that of the first embodiment and the beam control angle is to −70 degrees in the design.

In FIG. 25, a solid line A shows the case of forming the metal on the entire rear surface, and a solid line B shows the case of forming the metal only on the rear surfaces of the patches. In both cases, the beam is oriented in the desired direction of −70 degrees.

However, when the metal is formed on the entire rear surface, a radiation level in the direction of 0 degrees representing specular reflection is higher than a radiation level in the direction of −70 degrees. Specifically, as shown in the fourth embodiment of the present invention, it is understood that the model prepared by forming the metal ground plane only on the rear surfaces of the patches and peeling the metal off the inner surfaces of the patches shows a better characteristic.

### Fifth Embodiment of the Present Invention

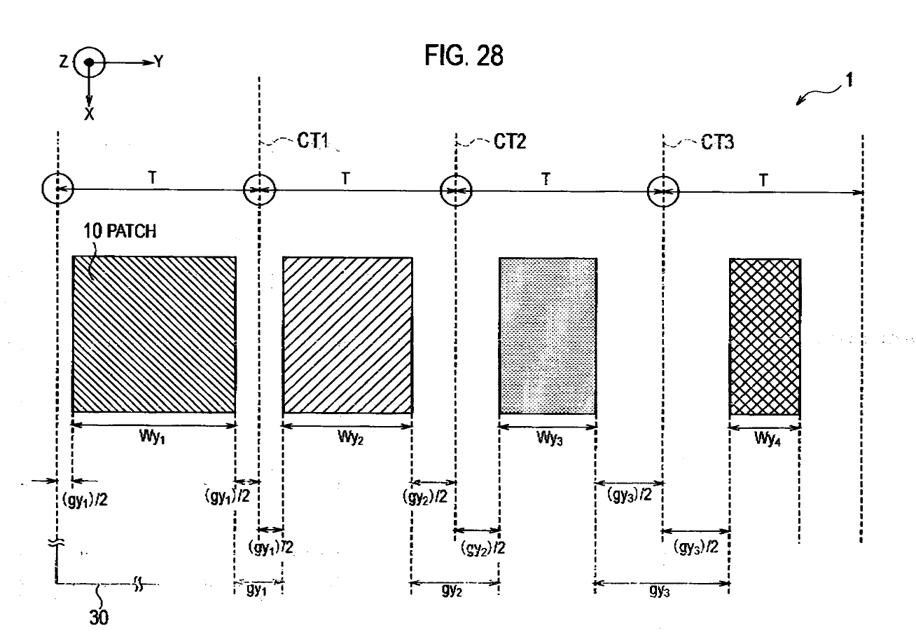

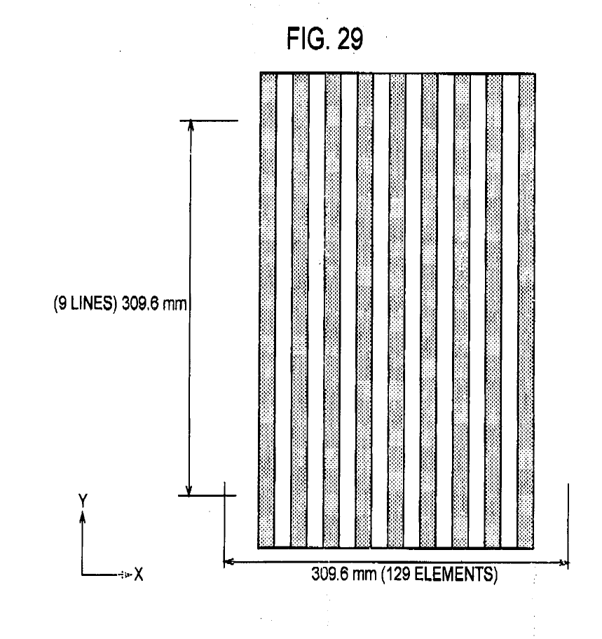

FIG. 28 shows a reflectarray 1 using a metamaterial according to a fifth embodiment of the present invention. Meanwhile, FIG. 29 shows an entire structure of the reflectarray 1 according to the fifth embodiment of the present invention. As shown in FIG. 28, in the reflectarray 1 according to this embodiment, each of mushroom structures is formed of one quadrilateral patch 10 but is not provided with the via hole 20 unlike the above-described embodiments. Specifically, the reflectarray 1 according to this embodiment has a so-called “via-less mushroom structure” (also referred to as EBG or HIS) in which the patch 10 is not connected to the ground plane 30. Moreover, as shown in FIG. 29, the multiple patches 10 are arranged in the horizontal direction (the x direction) and in the vertical direction (the y direction) of the ground plane 30.

Specifically, in the reflectarray 1 according to this embodiment, every interval between a center bisecting the gap between the adjacent patches and a center bisecting an adjacent gap which is adjacent to the gap is set equal respectively in the horizontal direction (the x direction) and in the vertical direction (the y direction) of the ground plane. The size of the gap is adjusted so that the value of the reflection phase of the reflected wave from the patches is set to a desired value.

In FIG. 28, the gap between the i-th patch “Pᵢ” and the adjacent (i+1)-th patch “Pᵢ₊₁” is denoted by “g_{yi}”. The value of the size of the gap “g_{yi}” is determined based on the value of the phase of the reflected wave that is the incident wave reflected by each of the patches, as similar to the above-described first embodiment of the present invention (see FIG. 9).

In the reflectarray 1 according to this embodiment, a gap “g_{y1}” between a patch having a length of “W_{y1}” and a patch adjacent to this patch and having a length of “W_{y2}” is bisected and denoted by a center CT1. Similarly, a gap “g_{y2}” between the patch having the length of “W_{y2}” and a patch adjacent to this patch and having a length of “W_{y3}” is bisected and denoted by a center CT2. Further, a gap “g_{y3}” between the patch having the length of “W_{y3}” and a patch adjacent to this patch and having a length of “W_{y4}” is bisected and denoted by a center CT3.

In the reflectarray 1 according to this embodiment, an interval T between the center CT1 and the center CT2 is adjusted to be equal to an interval T between the center CT2 and the center CT3.

According the reflectarray 1 described above, the reflection phase tends to coincide with the ideal value of the left-handed transmission line model as similar to the reflectarray 1 of the first embodiment of the present invention. Hence it is possible to suppress the situation where the phase difference is not constant as observed in the case of determining the lengths of the patches based on the method of designing the conventional reflectarray. In short, it is possible to significantly improve the performance of the reflectarray.

Hereinabove, the present invention has been described in detail using the above embodiment; however, it is apparent to those skilled in the art that the present invention is not limited to the embodiment described herein. Modifications and variations of the present invention can be made without departing from the spirit and scope of the present invention defined by the description of the scope of claims. Thus, what is described herein is for illustrative purpose, and has no intention whatsoever to limit the present invention.

Note that the entire content of Japanese Patent Application No. 2009-131585 [filed on May 29, 2009) is incorporated herein by reference.

### INDUSTRIAL APPLICABILITY

According to the present invention, it is possible to provide a reflectarray having an improved performance as compared to a conventional method when a metamaterial is used based on a left-handed transmission line model. Therefore, the present invention is useful for radio communications and the like.

### EXPLANATION OF THE REFERENCE NUMERALS

1 REFLECTARRAY
10 PATCH
20 VIA HOLE
30 GROUND PLANE
40 SUBSTRATE

1. A reflectarray formed by arranging a plurality of mushroom structures on a ground plane, wherein
each of the mushroom structures comprises:
one quadrilateral patch; and
a via configured to short the patch and the ground plane,
the adjacent vias are arranged to have equal intervals in a vertical direction of the ground plane, and
a size of each gap between the adjacent patches is adjusted so that a value of a reflection phase of a reflected wave from each of the patches is set to a desired value.

2. A reflectarray formed by arranging a plurality of mushroom structures on a ground plane, wherein
each of the mushroom structures comprises:
one quadrilateral patch; and
a via configured to short the patch and the ground plane,
when an interval “PT” from an edge of an i-th patch to an edge of an (i+1)-th patch is set to an equal value for all i parameters and a size of a gap between an i-th patch “Pᵢ” and an adjacent (i+1)-th patch “Pᵢ₊₁” is denoted by “g_{yi}”,
a length of the i-th patch is “2×W_{yi}”, and
an interval “IVhᵢ” between an i-th via “Vhᵢ” and an (i+1)-th via “Vhᵢ₊₁” is “W_{yi}+g_{yi}+W_{yi+1}”.

3. A reflectarray formed by arranging a plurality of mushroom structures on one ground plane, wherein
each of the mushroom structures comprises one quadrilateral patch,
every interval between a center bisecting a gap between the adjacent patches and a center bisecting an adjacent gap adjacent to the gap is set equal in a vertical direction of the ground plane, and
a size of the gap is adjusted so that a value of a reflection phase of a reflected wave from each of the patches is set to a desired value.

4. The reflectarray according to any one of claims 1 to 3, wherein
in a portion where there is no value of a gap “Δg” corresponding to the reflection phase “φ”, none of the mushroom structures is arranged on a surface of the reflectarray and the ground plane is not provided on a rear surface of the reflectarray, and
in a portion where there is a value of the gap “Δg” corresponding to the reflection phase “φ”, one of the mushroom structures is arranged on the surface of the reflectarray and the ground plane is provided on the rear surface of the reflectarray.

5. The reflectarray according to claim 1, wherein
when the interval between the vias is denoted by “T” and a size of a gap between an i-th patch “Pᵢ” and an adjacent (i+1)-th patch “Pᵢ₊₁” is denoted by “g_{yi}”,
the gap is located between an i-th via “Vhᵢ” and an adjacent (i+1)-th via “Vhᵢ₊₁”,
the size “g_{yi}” of the gap is determined based on a value of a phase of a reflected wave that is an incident wave reflected by each of the patches, and
when a difference obtained by subtracting the size “g_{yi}” of the gap from the interval “T” of the vias is “2×W_{yi}” and a length of the patch from each of the vias “Vhᵢ” and “Vhᵢ₊₁” to the gap is “W_{yi}”, a length of the i-th patch is “W_{y(i-1)}+W_{yi}”.
